(19) United States
(12) Patent Application Publication
(10) Pub. No.: US 2003/0233352 A1
(43) Pub. Date: Dec. 18, 2003

(54) Method and apparatus for screening media

(76) Inventor: Andrey George Baker, Bolney (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/391,664

(22) Filed: Mar. 19, 2003

Related U.S. Application Data
(60) Provisional application No. 60/366,211, filed on Mar. 21, 2002.

(51) Int. Cl. G06F 7/00

(52) U.S. Cl. 707/3

(57) ABSTRACT

A method of scanning media for licensed files is disclosed where the method involves reading the media to collect a name of a file stored on the media, storing the name of the file in a memory, comparing the name of the file to a name of a known file, determining whether the name of the file is sufficiently similar to the name of the known file, comparing the name of the file to a name of a licensed file and determining whether the name of the file is sufficiently similar to the name of the licensed file.

### BACKGROUND

Replicators take a master or original of some material such as music, videos, computer files, etc. and make copies. As an example, compact disc replicators take a master of some music which may be stored on a tape or other media and create as many copies as the customer requests.

In recent times, some customers have requested copies be made of masters of material when the customer does not have the legal right to make copies of the material. Such unauthorized copies reduce the revenue that rightly belongs to the legal owner of the media and subjects the replicator to legal liability for making authorized copies.

While replicators' business is to make copies, the responsibility to determine whether a customer has the legal right to make copies of material has fallen to the replicators. As a result, there is a need for replicators to quickly, efficiently and confidently determine whether a customer has the legal right to make copies of material.

### SUMMARY OF THE INVENTION

According to one aspect of the invention, a method of scanning media for licensed files is disclosed where the method may involve reading the media to collect a name of a file stored on the media, storing the name of the file in a memory, comparing the name of the file to a name of a known file, determining whether the name of the file is sufficiently similar to the name of the known file, comparing the name of the file to a name of a licensed file and determining whether the name of the file is sufficiently similar to the name of the licensed file. The media may be master media which is used as a source to make duplicates of the data stored on the master media. An administrator may be allowed to add, remove and edit the name of the known file, add, remove and edit the names of the licensed file, add, remove and edit a client wherein the client has licenses for a particular file and add, remove and edit the names of licensed files to a particular client.

According to another aspect of the invention, the method may determine whether the name of the file is similar to the name of the licensed file specific to a particular client. The method may compare the name of the file to a separate source for the name of the known file where the separate source for the name of the known file may be the Internet. The method may also determine whether the name of the file is the name of the known file and may display on a display unit whether the name of the file is similar to the name of the known file. The method may also display on a display unit whether the name of the file is similar to the name of the licensed file and whether the name of the file is not similar to the name of the known file. The names of the files may be separated by file type. The method may also forbid the duplication of files which are not known files and forbid the duplication of files which are not license files for a particular client.

According to another aspect of the invention, a screening apparatus is disclosed where the screening apparatus may have a display unit that is capable of generating video images, an input device, a media reading device, a network connecting device, a controller operatively coupled to the display unit, the value input device, the media reading device and the network connecting device, where the controller may have a processor and a memory operatively coupled to said processor. The controller may be programmed to read a piece of media to collect a name of a file stored on the media, store the name of the file in a memory, compare the name of the file to a name of a known file, determine whether the name of the file is sufficiently similar to the name of the known file, compare the name of the file to a name of a licensed file and determine whether the name of the file is sufficiently similar to the name of the licensed file. The media may be master media.

The controller may be programmed to allow an administrator to add, remove and edit the name of the known file, to add, remove and edit the names of licensed files, to allow an administrator to add, remove and edit a client wherein the client has licenses for particular names of files and to add, remove and edit the names of licensed files to a particular client. The controller may be programmed to determine whether the name of the file is similar to the name of the licensed file specific to a particular client. The controller may be programmed to compare the name of the file to a separate source for the name of the known file where the separate source for the name of the known file may be the Internet.

The controller may be further programmed to determine whether the name of the file is the name of the known file, to determine a size of the file, to compare the size of the file to the size of the known file, to determine whether the size of the file is sufficiently similar to the size of the known file, to determine a cyclical redundancy check of the file, to compare the cyclical redundancy check of the file to the cyclical redundancy check of the known file, to determine whether the cyclical redundancy check of the file is sufficiently similar to the cyclical redundancy check of the known file, to create a content analysis of the file, to compare the content analysis of the file to the content analysis of the known file and to determine whether the content analysis of the file is sufficiently similar to the content analysis of the known file. The content analysis may be a sound footprint analysis.

The controller may be further programmed to display on a display unit whether the name of the file is similar to the name of the known file, whether the name of the file is similar to the name of the licensed file, whether the size of the file is sufficiently similar to the size of the known file, whether the cyclical redundancy check of the file is sufficiently similar to the cyclical redundancy check of the known file and whether the content analysis of the file is sufficiently similar to the content analysis of the known file. The controller may be programmed to display the names of the files separated by file type. The controller also may be programmed to forbid the duplication of files which are not known files and to forbid the duplication of files which are not license files for a particular client.

According to another aspect of the invention, a memory having a computer program stored therein is disclosed where the computer program may be capable of being used in connection with a screening apparatus where the memory may have a first memory portion physically configured in accordance with computer program instructions that may cause the screening apparatus to allow a person to read a piece of media to collect a name of a file stored on the media, a second memory portion physically configured in accordance with computer program instructions that may cause the screening apparatus to store the name of the file in a memory, a third memory portion physically configured in accordance with computer program instructions that may cause the screening apparatus to compare the name of the file to a name of a known file, a fourth memory portion physically configured in accordance with computer program instructions that may cause the screening apparatus to determine whether the name of the file is sufficiently similar to the name of the known file, a fifth memory portion physically configured in accordance with computer program instructions that may cause the screening apparatus to compare the name of the file to a name of a licensed file and a sixth memory portion physically configured in accordance with computer program instructions that may cause the screening apparatus to determine whether the name of the file is sufficiently similar to the name of the licensed file.

The media may be master media used to make duplicates of the master media. The memory may additionally have an additional portion physically configured in accordance with computer program instructions that may cause the screening apparatus to allow an administrator to add, remove and edit the name of the known file, to allow an administrator to add, remove and edit the names of licensed files, to allow an administrator to add, remove and edit the names of licensed files to a particular client, to allow an administrator to add, remove and edit a client wherein the client has licenses for particular names of files and to add, remove and edit the names of licensed files to a particular client.

The memory may also have an additional portion physically configured in accordance with computer program instructions that may cause the screening apparatus to determine whether the name of the file is similar to the name of the licensed file specific to a particular client, to compare the name of the file to a separate source for the name of the known file, to search the Internet as the separate source for the name of the known file, to calculate a size of the file, to determine whether the name of the file is the name of the known file, to compare the size of the file to the size of the known file, to determine whether the size of the file is sufficiently similar to the size of the known file, to determine a cyclical redundancy check of the file, to compare the cyclical redundancy check of the file to the cyclical redundancy check of the known file, to determine whether the cyclical redundancy check of the file is sufficiently similar to the cyclical redundancy check of the known file, to create a content analysis of the file, to compare the content analysis of the file to the content analysis of the known file, to determine whether the content analysis of the file is sufficiently similar to the content analysis of the known file, to perform a sound footprint analysis as the content analysis of the file, to display on a display unit whether the name of the file is similar to the name of the known file, to display on a display unit whether the name of the file is similar to the name of the licensed file, to display on a display unit whether the size of the file is sufficiently similar to the size of the known file, to display on a display unit whether the cyclical redundancy check of the file is sufficiently similar to the cyclical redundancy check of the known file and to display on a display device whether the content analysis of the file is sufficiently similar to the content analysis of the known file. The memory may cause the screening apparatus to display the names of the files separated by file type. The memory may cause the screening apparatus to forbid the duplication of files which are not known files, which do not have sufficiently similar CRCs and which do not have a sufficiently similar content analysis.

### BRIEF DESCRIPTION OF THE DRAWINGS

FIG. 1 is a block diagram of an embodiment of a system in accordance with the invention;

FIG. 2 is a flowchart of an embodiment of a main routine that may be performed during operation of the system; and

FIGS. 3a, 3b and 3c are a flowchart spread over three pages of an alternative embodiment of a main routine that may be performed during operation of the system.

### DETAILED DESCRIPTION OF VARIOUS EMBODIMENTS

This application claims priority to provisional application serial No. 60/366,211 filed Mar. 21, 2002.

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, it is not intended that the scope of any claim element be interpreted based on the application of 35 U.S.C. §112, sixth paragraph.

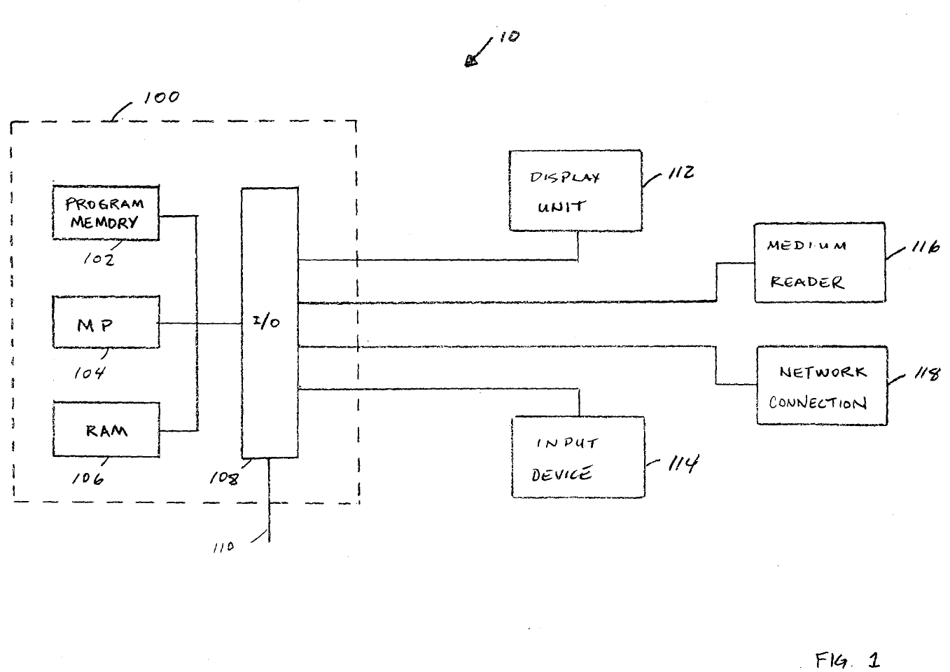

FIG. 1 is a block diagram of a number of components that may be incorporated in a screening unit apparatus 10. Referring to FIG. 1, the screening system 10 may include a controller 100 that may comprise a program memory 102, a microcontroller or microprocessor (MP) 104, a random-access memory (RAM) 106 and an input/output (I/O) circuit 108, all of which may be interconnected via an address/data bus 110. It should be appreciated that although only one microprocessor 104 is shown, the controller 100 may include multiple microprocessors 104. Similarly, the memory of the controller 100 may include multiple RAMs 106 and multiple program memories 102. Although the I/O circuit 108 is shown as a single block, it should be appreciated that the I/O circuit 108 may include a number of different types of I/O circuits. The RAM(s) 104 and program memories 102 may be implemented as semiconductor memories, magnetically readable memories, and/or optically readable memories, for example.

FIG. 1 illustrates that a display unit 112, an input device 114, a medium reader 116 and a network connection 118 may be operatively coupled to the I/O circuit 108, each of those components being so coupled by either a unidirectional or bidirectional, single-line or multiple-line data link, which may depend on the design of the component that is used.

As shown in FIG. 1, the components 112, 114, 116 and 118 may be connected to the I/O circuit 108 via a respective direct line or conductor. Different connection schemes could be used. For example, one or more of the components shown in FIG. 1 may be connected to the I/O circuit 108 via a common bus or other data link that is shared by a number of components. Furthermore, some of the components may be directly connected to the microprocessor 104 without passing through the I/O circuit 108.

The display unit 112 may be a tradition cathode ray tube device or a liquid crystal display or any other type of commercially available display unit. The input device 114 may be a keyboard, a computer mouse, a light pen, a scanner or the like. The medium reader 116 may be a disc drive (magnetic, optical or any other storage/retrieval system), a tape reader system, or any other method of storing and retrieving data. The network connection 118 may be a connection to the Internet, a connection to a virtual private network (VPN) or a connection to a multitude of additional computer systems.

### Overall Operation of the System

One manner in which the system 10 may operate is described below in connection with a number of flowcharts which represent a number of portions or routines of one or more computer programs, which may be stored in one or more of the memories of the controller 100. The computer program(s) or portions thereof may be stored remotely, outside of the system 10, and may control the operation of the system 10 from a remote location. Such remote control may be facilitated with the use of a wireless connection, or by an Internet interface that connects the system 10 with a remote computer having a memory in which the computer program portions are stored. The computer program portions may be written in any high level language such as C, C+, C++ or the like or any low-level, assembly or machine language. By storing the computer program portions therein, various portions of the memories 102, 106 are physically and/or structurally configured in accordance with computer program instructions.

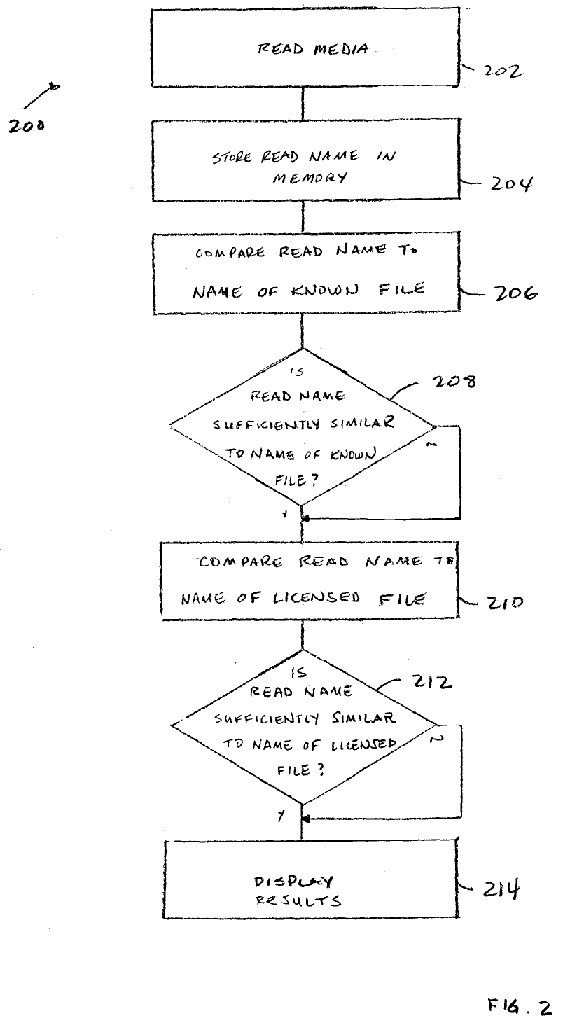

FIG. 2 is a flowchart of a main operating routine 200 that may be stored in the memory of the controller 100. Referring to FIG. 2, the main routine 200 may begin operation at block 202. At block 202, the system 10 may read a piece of media to collect a name of a file stored on the media. The media may be a master of a data file that a client wishes to have duplicated. The data on the disc may be any type of data including executable files, sound files, picture files, moving picture files or any other type of file capable of being stored on the media. The media may be stored on a magnetic disc, an optical disc, a tape system or any other type of medium used to hold data. The system 10 may read the entire media or just a portion of the media. Accordingly, the system 10 may gather all the names of all the files on the media at one time or the system 10 may gather a name of a first file and analyze that name of the first file and then may gather a name of a second file and analyze that name of the second file. The system 10 may also just read the names of files of a particular type such as file with an .exe extension or files with a .wav extension. The system 10 may also read in various parts of the file including the file size, the file type and the file itself all of which can be analyzed to attempt to match read files with known files.

At block 204, the name of the file that was read may be stored in a memory. The memory may be a random access memory or any other type of appropriate memory. At block 206, the name of the file read at block 202 may be compared to a name of a known file. The name of the known file may be stored in a memory as part of the system 10 or may be stored remotely and accessed through the network connection 118. The name of the known file may be part of a list of files that have been collected and stored as files that are already in existence and may require that a license be obtained before duplication of the files is permitted. The system may compare the name of the file read at block 202 to an entire list of names of known files or may compare it to files with similar filename extensions such as .wav or .exe. The names of the known files may be stored in a database.

At block 208, the system 10 may determine whether the name of the file is sufficiently similar to the name of the known file. The system 10 may first determine if there is an exact match between the name of the read file and the name of the known file. The system 10 also may determine whether there are similarities between the name of the read file and the name of the known file. For example, there may be a single letter or other ASCII character that is different between the read name and the known name. As another example, the known name may be part but not all of the read name. As understood by one skilled in the art, there are a variety of ways, such as using fuzzy logic, to determine if a first name is similar to a second name. In addition, the sensitivity of the comparison can be changed. For example, the system 10 may only look for an exact match or the system may look for a certain percentage of the letters (or ASCII characters) to be similar.

At block 210, the system 10 compares the name of the file to a name of a licensed file. Licensed files are files that a particular client has a license to use or duplicate. The name of the licensed file may be stored in a memory as part of the system 10 or may be stored remotely and accessed through the network connection 118. The name of the licensed file may be part of a list of files that have been stored as files that are licensed for a particular user. The system may compare the name of the file read at block 202 to an entire list of names of licensed files or may compare it to files with similar filename extensions such as .wav or .exe. The names of the licensed files may be stored in a database.

At block 212, the system 10 determines whether the name of the file is sufficiently similar to the name of the licensed file. The system 10 may first determine if there is an exact match between the name of the read file and the name of the licensed file. The system 10 also may determine whether there are similarities between the name of the read file and the name of the licensed file. For example, there may be a single letter or other ASCII character that is different between the read name and the name of the licensed file name. As another example, the licensed name may be part but not all of the read name. As understood by one skilled in the art, there are a variety of ways, such as using fuzzy logic, to determine if a first name is similar to a second name. In addition, the sensitivity of the comparison can be changed. For example, the system 10 may only look for an exact match or the system may look for a certain percentage of the letters (or ASCII characters) to be similar. At block 214, the system 10 may display the determinations of step 208 or 212 on the display unit 112 and if either of the determinations is negative, the system 10 may forbid duplications to be made.

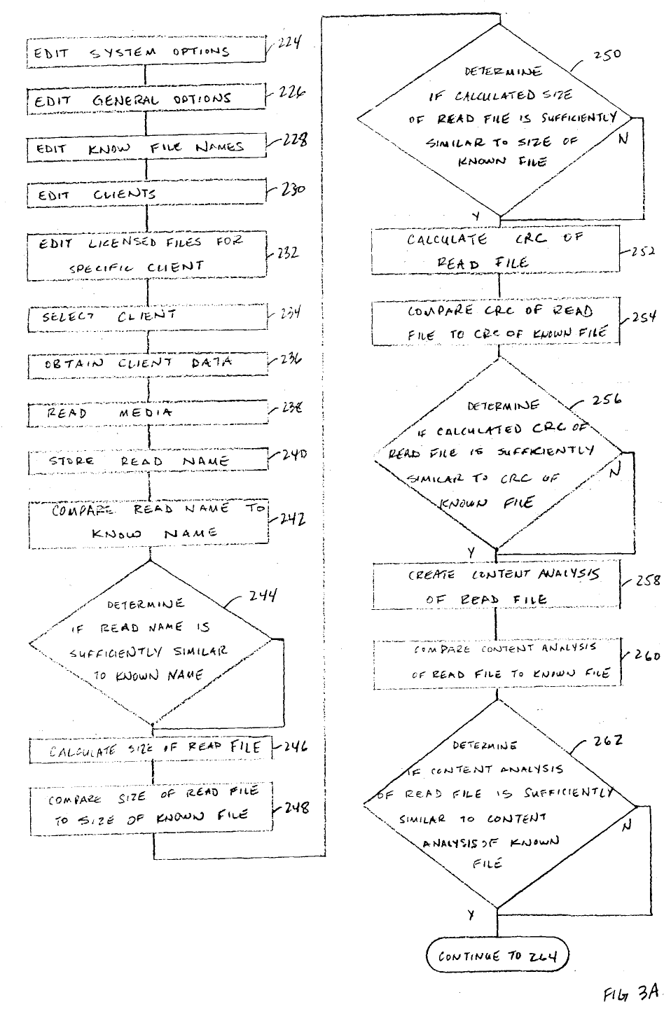

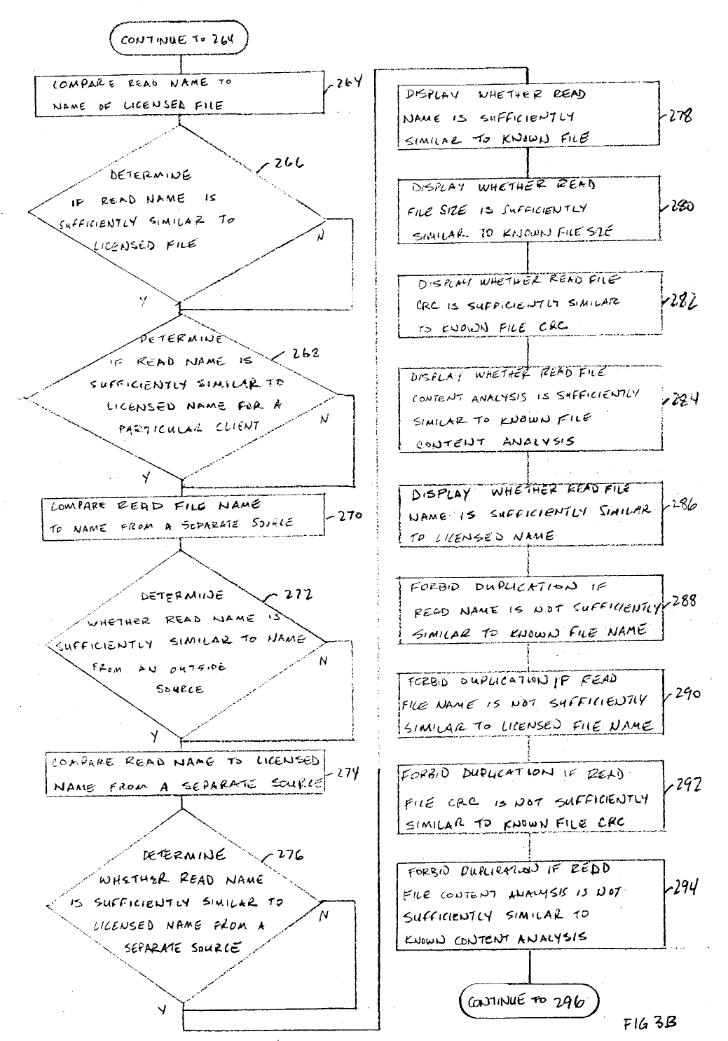

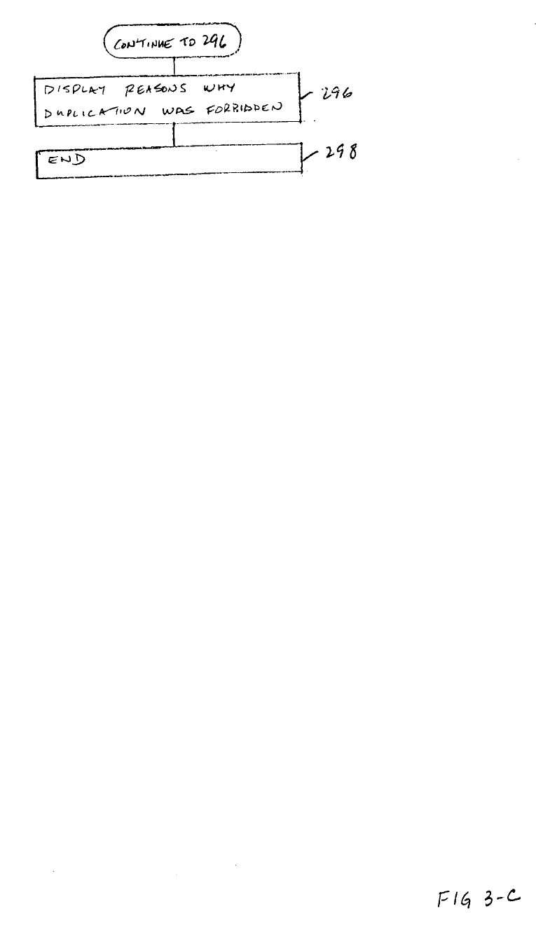

FIG. 3 represents another routine 222 operable on the system 10. At block 224, an administrator is permitted to edit the options of the system 10. The administrator is someone with additional authority who is authorized to make changes to the system 10 beyond merely using the system 10. Initially, the system 10 has various options preset to the most used positions. At step 226, the general options of the system 10 can be changed. Examples of the general options include the default scanning device (where the system 10 will look for the media to be scanned), the default report option (default or special), the file size check option (whether or not to attempt to match file sizes), the file CRC check option (whether or not to attempt to match file CRC calculation discussed further in this patent), the scan inside ZIP option (whether to unzip files and check the resulting files or not), the check all files or selected files option, the reports directory path option (where to send the report), the slideshow delay value option (how much time in seconds should there be between different report displays), and a direct draw acceleration option. Examples of email options include the name of the client, the email address of the client, the reply address of the client, the copy client option, the messages to this address option, the SMTP server option (email access to the system) and the SMTP port option (email access to the system).

At block 228, an administrator is permitted to add, remove and edit which name of files are names of the known files. By adding names of files of known files, the original owner of the files can be identified and further information about the file can be obtained. When adding a file, numerous details or parameters may be required. For example, the system 10 may have input fields for the file name, a name of an application associated with the name of the file, the web address of a license, the file owner, whether the file requires a license to be reproduced, whether each product requires a license, file components, the size of the file, the CRC of the file and a monitor clipboard URLs option where the last URL used in a web browser is copied and added to the relevant input field. Such information may be entered by hand by typing on a keyboard for example or may be imported from a memory in communication with the system. Each of parameters may also be edited.

At block 230, the administrator is allowed to add, remove and edit a client. Clients are users of the system 10. Clients may need to have licenses before they duplicate files. Certain clients may have licenses to specific files and not all clients have the same licenses. By adding clients, the specific licenses held by each client can be noted. In addition, valuable contact information about each client can be added, such as the client name, the contact name at the client and the email address of the client. Such information may be entered by hand by typing on an input device 114 such as a keyboard for example or may be imported from a memory in communication with the system. The information can update current client information or replace current client information.

At block 232, the administrator may be allowed to add, remove and edit the names of licensed files for specific clients. As previously stated, a replicator may have numerous clients and each client may hold different licenses to reproduce certain files. Clients may obtain or decline licenses. The administrator can add these changes to the system and keep the most current information in the system.

At block 234, the user may select a client from a list of clients previously added to the system by the administrator. At block 236, the system may obtain data regarding the client selected. The data may relate to the licenses held by the client. The data may be stored in a memory that is in communication with the system, such as a hard drive, and may be stored in the form of a database.

Blocks 238 to 244 are similar to blocks 202-208 of FIG. 2. At block 238, the system 10 may read a piece of media to collect data stored on the media, including a name of a file stored on the media. At block 240, the name of the file that was read may be stored in a memory. At block 242, the name of the file read at block 238 may be compared to a name of a known file. At block 244, the system 10 may determine whether the name of the file is sufficiently similar to the name of the known file. If the system 10 determines that the name of the read file is not sufficiently similar to the known file, the system 10 may skip to block 270.

If at block 244 the system 10 determined that the name of the read file is sufficiently similar to the name of a known file, at a block 246, the system 10 may calculate the size of the file that was read. Modem operating systems determine the size of files in bytes. The same file on different computers should have the same file size, assuming the file has not been modified. At block 248, the system 10 may compare the size of the read file to the size of the known file. At block 250, the system 10 may determine whether the size of the file is sufficiently similar to the size of the known file. The system 10 may look for an exact file size match or may look for a file size within a certain percentage of the size of the known file.

If at block 250 the system 10 determines that the size of the file is sufficiently similar to the size of the known file, at block 252 the system 10 may calculate the Cyclical Redundancy Check (“CRC”) or Code of the read file. CRC creates a standard ‘code’ almost unique to a particular file. CRC techniques are well known in the art and are often described in connection with detecting errors in data transmissions, such as data transmissions by a modem. At block 254, the system may compare the CRC code of the read file to the CRC of the known file. The CRC of the known file may be entered and stored in a memory in communication with the system 10 by the administrator of the system. At block 256, the system may determine whether the CRC of the read file is sufficiently similar to the CRC. The system 10 may require the calculated CRC of the read file to be with a certain percentage of the CRC of the known file.

At block 258, the system 10 may create a content analysis of a file by performing a content analysis routine on the file. For example, if the file is an audio file, the system 10 may determine a audio footprint of the file. The result of the audio footprint analysis is a unique identifier of the audio file. The audio footprint for a specific file will be the same each time it is analyzed. Accordingly, the system 10 may be able to determine if two audio files contain similar content even if the file names have been modified to be different. Audio footprint software is readily available in the public domain, such as on the web site www.shareware.com. In addition, content analysis software for other file types such as media files, application files, graphic files, document files, etc. are available.

At block 260, the system may compare the content analysis of the read file to the content analysis of the known file. The content analysis of the known file may be stored in a memory in communication with the system 10 or may be loaded in from an external source in communication with the system 10. At block 262, the system may determine whether the content analysis of the read file is sufficiently similar to that of the known file. As described previously, the system 10 may require that the content analysis be an exact match or the system may allow for some amount of differences between the read file and the known file.

At block 264, the system 10 may compare the name of the file to a name of a licensed file. At block 266, the system 10 determines whether the name of the file is sufficiently similar to the name of the licensed file.

At block 268, the system 10 determines whether the name of the read file is sufficiently similar to the name of the licensed file specific to a particular client. As described with respect to block 208, there are a variety of ways to determine whether two files are sufficiently similar, including determining whether there is an exact file name match.

At block 270, the system IO may compare the name of the read file to a separate source for the name of the known file. For example, the system 10 may search the Internet for the name of the read file to determine if the file is known. The system 10 may search virtual private networks set up by large music or software publishers, for example, to determine is the name of the read file is known.

At block 272, the system 10 may determine whether the name of the file is sufficiently similar to the name of the known file found on the secondary source. As described with respect to block 208, there are a variety of ways to determine whether two files are sufficiently similar, including determining whether there is an exact file name match.

At block 274, the system 10 may compare the name of the read file to a separate source for the name of the licensed file. For example, the system 10 may search the Internet for the name of the read file to determine if the file is licensed. The system 10 may search virtual private networks set up by large music or software publishers, for example, to determine is the name of the read file is licensed.

At block 276, the system 10 may determine whether the name of the file is sufficiently similar to the name of the licensed file found on the secondary source. As described with respect to block 208, there are a variety of ways to determine whether two files are sufficiently similar, including determine whether there is an exact file name match.

At block 278, the system 10 may display on the display device 112 whether the name of the file is similar to the name of the known file. At block 280, the system 10 may display on the display device 112 whether the size of the read file is similar to the size of the known file. At block 282, the system 10 may display on the display device 112 whether the calculated CRC of the read file is similar to the CRC of the known file. At block 284, the system 10 may display on the display device 112 whether the content analysis of the read file is sufficiently similar to the content analysis of the known file.

At block 286, the system 10 may display on the display device 112 whether the name of the file is similar to the name of the licensed file. In an alternative arrangement, the name of the files can sorted and displayed by the type of file. For example, all the music files with extension such as .wav and .mp3 could be displayed together and all the image files such as file with extensions such as .tif and .jpg could be displayed together, either on the same screen or on different screens.

In yet another alternative arrangement, the name of the read file may be displayed on the display unit followed by the determination of whether the file is known or unknown and licensed or unlicensed for a particular client.

At block 288, the system 10 may forbid the duplication of the files that are not known. If the name of the read file is not known, there is a chance that the name of the file has been purposely altered such that it would be difficult for the media replicator to know that the read file is really a file that requires a license to be replicated. Accordingly, the system may forbid the replication of the read file name that is not known. At block 290, the system 10 may forbid the duplication of the files that are not licensed. The media replicator faces significant problems if it make duplicates of a file that is not licensed. Accordingly, the system may prevent unlicensed files from being replicated.

At block 292, the system 10 may forbid the duplication of the files that do not have a sufficiently similar CRCs. At block 294, the system 10 may forbid the duplication of the files that do not have a sufficiently similar content analysis. At block 296, the system 10 may report to the client any problems that would forbid duplication such as the name of the read file does not match the known file name, the read file is not licensed, the read file does not have a sufficiently similar CRC or the read file does not have a sufficiently similar content analysis.

At block 298, the method 220 ends.

1. A method of scanning media for licensed files, the method comprising:
reading the media to collect a name of a file stored on the media;
storing the name of the file in a memory;
comparing the name of the file to a name of a known file;
determining whether the name of the file is sufficiently similar to the name of the known file;
comparing the name of the file to a name of a licensed file; and
determining whether the name of the file is sufficiently similar to the name of the licensed file.

2. The method of claim 1 wherein the media is master media which is used as a source to make duplicates of the data stored on the master media.

3. The method of claim 1, further comprising allowing an administrator to add, remove and edit the name of the known file.

4. The method of claim 1, further comprising allowing an administrator to add, remove and edit the names of the licensed file.

5. The method of claim 1, further comprising allowing an administrator to add, remove and edit a client wherein the client has licenses for a particular file.

6. The method of claim 1, further comprising allowing an administrator to add, remove and edit the names of licensed files to a particular client.

7. The method of claim 1, further comprising determining whether the name of the file is similar to the name of the licensed file specific to a particular client.

8. The method of claim 1, further comprising comparing the name of the file to a separate source for the name of the known file.

9. The method of claim 8, wherein the separate source for the name of the known file is the Internet.

10. The method of claim 1, further comprising determining whether the name of the file is the name of the known file.

11. The method of claim 1, further comprising displaying on a display unit whether the name of the file is similar to the name of the known file.

12. The method of claim 1, further comprising displaying on a display unit whether the name of the file is similar to the name of the licensed file.

13. The method of claim 1, further comprising displaying whether the name of the file is not similar to the name of the known file.

14. The method of claim 1, further comprising displaying the names of the files separated by file type.

15. The method of claim 1, further comprising forbidding the duplication of files which are not known files.

16. The method of claim 1, further comprising forbidding the duplication of files which are not license files for a particular client.

17. A screening apparatus, comprising
a display unit that is capable of generating video images;
an input device;
a media reading device;
a network connecting device;
a controller operatively coupled to said display unit, said value input device, said media reading device and said network connecting device said controller comprising a processor and a memory operatively coupled to said processor,
said controller being programmed to read a piece of media to collect a name of a file stored on the media;
said controller being programmed to store the name of the file in a memory;
said controller being programmed to compare the name of the file to a name of a known file;
said controller being programmed to determine whether the name of the file is sufficiently similar to the name of the known file;
said controller being programmed to compare the name of the file to a name of a licensed file; and
said controller being programmed to determine whether the name of the file is sufficiently similar to the name of the licensed file.

18. The screening apparatus of claim 17, wherein the media is master media.

19. The screening apparatus of claim 17, wherein the controller is further programmed to allow an administrator to add, remove and edit the name of the known file.

20. The screening apparatus of claim 17, wherein the controller is further programmed to allow an administrator to add, remove and edit the names of licensed files.

21. The screening apparatus of claim 17, wherein the controller is further programmed to allow an administrator to add, remove and edit a client wherein the client has licenses for particular names of files.

22. The screening apparatus of claim 17, wherein the controller is further programmed to allow an administrator to add, remove and edit the names of licensed files to a particular client.

23. The screening apparatus of claim 17, wherein the controller is further programmed to determine whether the name of the file is similar to the name of the licensed file specific to a particular client.

24. The screening apparatus of claim 17, wherein the controller is further programmed to compare the name of the file to a separate source for the name of the known file.

25. The screening apparatus of claim 17, wherein the separate source for the name of the known file is the Internet.

26. The screening apparatus of claim 17, wherein the controller is further programmed to determine whether the name of the file is the name of the known file.

27. The screening apparatus of claim 17, wherein the controller is further programmed to determine a size of the file.

28. The screening apparatus of claim 17, wherein the controller is further programmed to compare the size of the file to the size of the known file.

29. The screening apparatus of claim 17, wherein the controller is further programmed to determine whether the size of the file is sufficiently similar to the size of the known file.

30. The screening apparatus of claim 17, wherein the controller is further programmed to determine a cyclical redundancy check of the file.

31. The screening apparatus of claim 17, wherein the controller is further programmed to compare the cyclical redundancy check of the file to the cyclical redundancy check of the known file.

32. The screening apparatus of claim 17, wherein the controller is further programmed to determine whether the cyclical redundancy check of the file is sufficiently similar to the cyclical redundancy check of the known file.

33. The screening apparatus of claim 17, wherein the controller is further programmed to create a content analysis of the file.

34. The screening apparatus of claim 17, wherein the controller is further programmed to compare the content analysis of the file to the content analysis of the known file.

35. The screening apparatus of claim 17, wherein the controller is further programmed to determine whether the content analysis of the file is sufficiently similar to the content analysis of the known file.

36. The screening apparatus of claim 33, wherein the content analysis is a sound footprint analysis.

37. The screening apparatus of claim 17, wherein the controller is further programmed to display on a display unit whether the name of the file is similar to the name of the known file.

38. The screening apparatus of claim 17, wherein the controller is further programmed to display on a display unit whether the name of the file is similar to the name of the licensed file.

39. The screening apparatus of claim 17, wherein the controller is further programmed to display on a display unit whether the size of the file is sufficiently similar to the size of the known file.

40. The screening apparatus of claim 17, wherein the controller is further programmed to display on a display unit whether the cyclical redundancy check of the file is sufficiently similar to the cyclical redundancy check of the known file.

41. The screening apparatus of claim 17, wherein the controller is further programmed to display on a display device whether the content analysis of the file is sufficiently similar to the content analysis of the known file.

42. The screening apparatus of claim 17, wherein the controller is further programmed to display the names of the files separated by file type.

43. The screening apparatus of claim 17, wherein the controller is further programmed to forbid the duplication of files which are not known files.

44. The screening apparatus of claim 17, wherein the controller is further programmed to forbid the duplication of files which are not license files for a particular client.

45. A memory having a computer program stored therein, said computer program being capable of being used in connection with a screening apparatus, said memory comprising:
a first memory portion physically configured in accordance with computer program instructions that would cause the screening apparatus to allow a person to read a piece of media to collect a name of a file stored on the media;
a second memory portion physically configured in accordance with computer program instructions that would cause the screening apparatus to store the name of the file in a memory;
a third memory portion physically configured in accordance with computer program instructions that would cause the screening apparatus to compare the name of the file to a name of a known file;
a fourth memory portion physically configured in accordance with computer program instructions that would cause the screening apparatus to determine whether the name of the file is sufficiently similar to the name of the known file;
a fifth memory portion physically configured in accordance with computer program instructions that would cause the screening apparatus to compare the name of the file to a name of a licensed file; and
a sixth memory portion physically configured in accordance with computer program instructions that would cause the screening apparatus to determine whether the name of the file is sufficiently similar to the name of the licensed file.

46. A memory as defined in claim 45 wherein the media is master media used to make duplicates of the master media.

47. A memory as defined in claim 45 wherein said memory additionally comprises an additional portion physically configured in accordance with computer program instructions that would cause the screening apparatus to allow an administrator to add, remove and edit the name of the known file.

48. A memory as defined in claim 45 wherein said memory additionally comprises an additional portion physically configured in accordance with computer program instructions that would cause the screening apparatus to allow an administrator to add, remove and edit the names of licensed files.

49. A memory as defined in claim 45 wherein said memory additionally comprises an additional portion physically configured in accordance with computer program instructions that would cause the screening apparatus to allow an administrator to add, remove and edit the names of licensed files to a particular client.

50. A memory as defined in claim 45 wherein said memory additionally comprises an additional portion physically configured in accordance with computer program instructions that would cause the screening apparatus to allow an administrator to add, remove and edit a client wherein the client has licenses for particular names of files.

51. A memory as defined in claim 45 wherein said memory additionally comprises an additional portion physically configured in accordance with computer program instructions that would cause the screening apparatus to allow an administrator to add, remove and edit the names of licensed files to a particular client.

52. A memory as defined in claim 45 wherein said memory additionally comprises an additional portion physically configured in accordance with computer program instructions that would cause the screening apparatus to determine whether the name of the file is similar to the name of the licensed file specific to a particular client.

53. A memory as defined in claim 45 wherein said memory additionally comprises an additional portion physically configured in accordance with computer program instructions that would cause the screening apparatus to compare the name of the file to a separate source for the name of the known file.

54. A memory as defined in claim 45 wherein said memory additionally comprises an additional portion physically configured in accordance with computer program instructions that would cause the screening apparatus to search the Internet as the separate source for the name of the known file.

55. A memory as defined in claim 45 wherein said memory additionally comprises an additional portion physically configured in accordance with computer program instructions that would cause the screening apparatus to determine a size of the file.

56. A memory as defined in claim 45 wherein said memory additionally comprises an additional portion physically configured in accordance with computer program instructions that would cause the screening apparatus to determine whether the name of the file is the name of the known file.

57. A memory as defined in claim 45 wherein said memory additionally comprises an additional portion physically configured in accordance with computer program instructions that would cause the screening apparatus to compare the size of the file to the size of the known file.

58. A memory as defined in claim 45 wherein said memory additionally comprises an additional portion physically configured in accordance with computer program instructions that would cause the screening apparatus to determine whether the size of the file is sufficiently similar to the size of the known file.

59. A memory as defined in claim 45 wherein said memory additionally comprises an additional portion physically configured in accordance with computer program instructions that would cause the screening apparatus to determine a cyclical redundancy check of the file.

60. A memory as defined in claim 45 wherein said memory additionally comprises an additional portion physically configured in accordance with computer program instructions that would cause the screening apparatus to compare the cyclical redundancy check of the file to the cyclical redundancy check of the known file.

61. A memory as defined in claim 45 wherein said memory additionally comprises an additional portion physically configured in accordance with computer program instructions that would cause the screening apparatus to determine whether the cyclical redundancy check of the file is sufficiently similar to the cyclical redundancy check of the known file.

62. A memory as defined in claim 45 wherein said memory additionally comprises an additional portion physically configured in accordance with computer program instructions that would cause the screening apparatus to create a content analysis of the file.

63. A memory as defined in claim 45 wherein said memory additionally comprises an additional portion physically configured in accordance with computer program instructions that would cause the screening apparatus to compare the content analysis of the file to the content analysis of the known file.

64. A memory as defined in claim 45 wherein said memory additionally comprises an additional portion physically configured in accordance with computer program instructions that would cause the screening apparatus to determine whether the content analysis of the file is sufficiently similar to the content analysis of the known file.

65. A memory as defined in claim 62 wherein said memory additionally comprises an additional portion physically configured in accordance with computer program instructions that would cause the screening apparatus to perform a sound footprint analysis as the content analysis of the file.

66. A memory as defined in claim 45 wherein said memory additionally comprises an additional portion physically configured in accordance with computer program instructions that would cause the screening apparatus to display on a display unit whether the name of the file is similar to the name of the known file.

67. A memory as defined in claim 45 wherein said memory additionally comprises an additional portion physically configured in accordance with computer program instructions that would cause the screening apparatus to display on a display unit whether the name of the file is similar to the name of the licensed file.

68. A memory as defined in claim 45 wherein said memory additionally comprises an additional portion physically configured in accordance with computer program instructions that would cause the screening apparatus to display on a display unit whether the size of the file is sufficiently similar to the size of the known file.

69. A memory as defined in claim 45 wherein said memory additionally comprises an additional portion physically configured in accordance with computer program instructions that would cause the screening apparatus to display on a display unit whether the cyclical redundancy check of the file is sufficiently similar to the cyclical redundancy check of the known file.

70. A memory as defined in claim 45 wherein said memory additionally comprises an additional portion physically configured in accordance with computer program instructions that would cause the screening apparatus to display on a display device whether the content analysis of the file is sufficiently similar to the content analysis of the known file.

71. A memory as defined in claim 45 wherein said memory additionally comprises an additional portion physically configured in accordance with computer program instructions that would cause the screening apparatus to display the names of the files separated by file type.

72. A memory as defined in claim 45 wherein said memory additionally comprises an additional portion physically configured in accordance with computer program instructions that would cause the screening apparatus to forbid the duplication of files which are not known files.

73. A memory as defined in claim 45 wherein said memory additionally comprises an additional portion physically configured in accordance with computer program instructions that would cause the screening apparatus to forbid the duplication of files which do not have sufficiently similar CRCs.

74. A memory as defined in claim 45 wherein said memory additionally comprises an additional portion physically configured in accordance with computer program instructions that would cause the screening apparatus to forbid the duplication of files which do not have a sufficiently similar content analysis.
